(19) United States
(12) Patent Application Publication
(10) Pub. No.: US 2002/0092395 A1
(43) Pub. Date: Jul. 18, 2002

(54) CLAMPING DEVICE FOR A TUBULAR COMPONENT, ESPECIALLY BY MEANS OF MOVEABLE JAWS

(76) Inventor: BERNARD EMILIAN, (FR)

Correspondence Address: WALL MARJAMA & BILINSKI, 101 SOUTH SALINA STREET, SUITE 400, SYRACUSE, NY, 13202, US

(21) Appl. No.: 09/028,989

(22) Filed: Feb. 25, 1998

(30) Foreign Application Priority Data
Nov. 21, 1997 (FR) 97.14883

(51) Int. Cl. B26D 3/00

(52) U.S. Cl. 83/452; 83/54

(57) ABSTRACT

The device comprises:

at least two concentric rings or plates (1) (2) arranged so that their faces are opposite each other in a tangential or virtually tangential position,

the rings or plates (1) (2) are mounted so that they can move relative to each other,

one of the plates (1) has features for mounting jaws (4) so that they are capable of guided translatory motion, said features having an even angular offset around the circumference,

each jaw (4) is guided by a ramp (2a) that acts as a cam carried by the other disc or plate (2),

the cams (2a) are arranged concentrically in order to allow, during rotation, especially of plate (2) accommodating said cams (2a), concomitant translatory and concentric motion of the various jaws (4) relative to the component to be processed which is secured between said jaws (4).

The invention relates to the technical field of machine tools.

The problem which the invention aims to solve is to ensure clamping of any type of tubular components, in particular, of round or other cross section so that the component can undergo a cutting and/or chamfering operation or any other machining operation such as a scalping operation.

In particular, but not exhaustively, the invention concerns apparatus of the type having a lever that can be moved in a circle relative to the component to be machined. The end of the lever or arm is fitted with a cutting or other unit, in the form of a circular saw blade for example, that can be driven and rotated in order to cut the tubular component concomitantly with rotational movement of the lever relative to said component which remains fixed during this operation and is kept clamped by means of various fixtures. The cutting or other unit may also be mounted so that its translatory motion can be adjusted in order to modify, as required, the cutting depth or any other machining operation thus performed on the tubular component. These technical arrangements concerning the machining of the tubular component as such are not described in detail because they are completely familiar to those skilled in the art and may be the subject of various alternative implementations. The cutting unit in the form of a circular saw can be combined with a chamfering tool. Similarly, the cutting or other operation may perfectly well be performed according to other principles that do not involve any movement of an arm or lever fitted with a machining tool which can be moved in a circle relative to the tubular component to be processed. Generally speaking, this type of machine is often intended to be transported directly to a construction or other site in order to process tubular components.

Regardless of the type of machine, it is very important to obtain perfect clamping of the component during the machining operation. The means of clamping used on this type of machine are not entirely satisfactory in the sense that the clamping forces are not evenly distributed around the circumference of the component to be processed and this makes the effectiveness of clamping highly unpredictable. Other technical solutions are relatively complicated to put into use. Similarly, they are sometimes awkward to use when the apparatus is used on site.

European Patent 0240908 discloses a tool for scalping tubes by means of a cutting tool that forms a long chip, this tool being mounted on a support which is capable of turning around the tube in question and is guided around the latter by means of rollers. To ensure clamping of the tool, the support has two stirrup pieces that can be pushed apart relative to a hinge and pushed together in opposition to the force of a spring. The cutting guide is shaped as a cutting blade and has a guide element that forms, at the same time as two roller-guide elements, a 3-point support for the tool on the tube.

In this embodiment the cutting tool is directly involved in clamping and securing the tubular component during cutting. It therefore has limited applications and the required clamping is not always very effective.

Patent WO97/27968 discloses a device for cutting tubes into lengths and chamfering them, especially thin tubes. Once again the device has applications for a machine or apparatus of the type described above. The clamping device as such is fitted with several jaws of different diameters with a peripheral surface of semicircular cross section so that it can be used alternatively depending on the dimensions of the tube to be machined whilst giving the tube to be machined its appropriate shape during the clamping operation.

It is therefore apparent that each jaw must be very closely adjusted to the diameter of the tube to be processed.

The invention has set itself the aim of overcoming these drawbacks in a simple, safe, effective and efficient manner.

The problem which the invention aims to solve is to obtain very high-speed concentric clamping with the possibility of obtaining very large clearances inside the jaws because the number of jaws is not limited.

In order to solve such a problem, a device for clamping a tubular component, especially by means of moveable jaws, has been devised and developed and comprises:

at least two concentric rings or plates arranged so that their faces are opposite each other in a tangential or virtually tangential position,

the rings or plates are mounted so that they can move relative to each other,

one of the plates has features for mounting jaws so that they are capable of guided translatory motion, said features having an even angular offset around the circumference,

each jaw is guided by a ramp that acts as a cam carried by the other disc or plate, - the cams are arranged concentrically in order to allow, as the plate accommodating said cams is rotated, concomitant translatory and concentric motion of the various jaws relative to the component to be processed which is secured between said jaws.

These characteristics result in the following essential advantages:

very high-speed concentric clamping,

jaw inside clearances ranging from several millimeters to several meters,

very large number of jaws depending on the application,

reduced overall dimensions,

reduced weight.

In order to solve the problem of obtaining very high-speed concentric clamping, each jaw is guided by a ramp by means of a roller mounted on an. arm, one end of which is fitted with said jaw. The features of the plate for movement of the jaws consist of parallelepiped impressions formed in the thickness of said plate in a radial pattern.

In order to solve the problem of allowing the component to be processed to be secured between the jaws, each impression opens out into an empty space formed concentrically with the plates and in which the object to be clamped is fitted.

In order to solve the problem of allowing concentric and concomitant movement of the various jaws, each ramp consists of a semicircular impression in an arc of a circle facing towards the centre of the corresponding plate, the length of the arc being determined so that when the rollers are positioned at one of the ends of the corresponding impression, the jaws are in their maximum spread position whereas when said rollers are positioned at the other end of said impression, the jaws are in their maximum clamping position.

In order to solve the problem of allowing relative movement of the rings or plates that accommodate the jaws on the one hand and the ramps on the other hand between the two rings or plates, a bearing is fitted in order to ensure rotation of roughly 45° between said plates. One of the plates, especially the cam-holder plate, is controlled by manual or automatic means in order to allow rotational movement of the two plates relative to each other.

In one embodiment of the clamping device, but in no way exhaustively, a lever is fitted opposite one of the plates with the ability of circular and concentric movement relative to said plate and one of the ends of this lever carries at least one rotating tool in order to perform a machining operation on the object that is clamped between the jaws.

The invention is explained below in greater detail, reference being made to the accompanying figures in which:

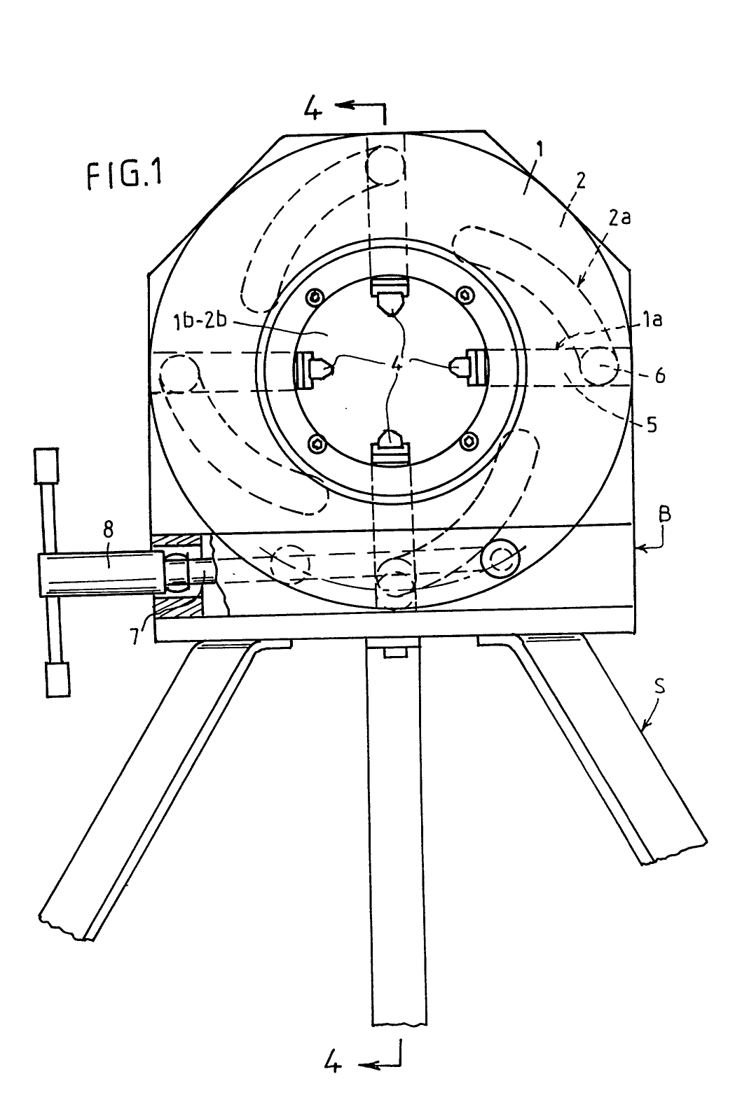

FIG. 1 is a partial front cutaway view with the jaws in their maximum spread position.

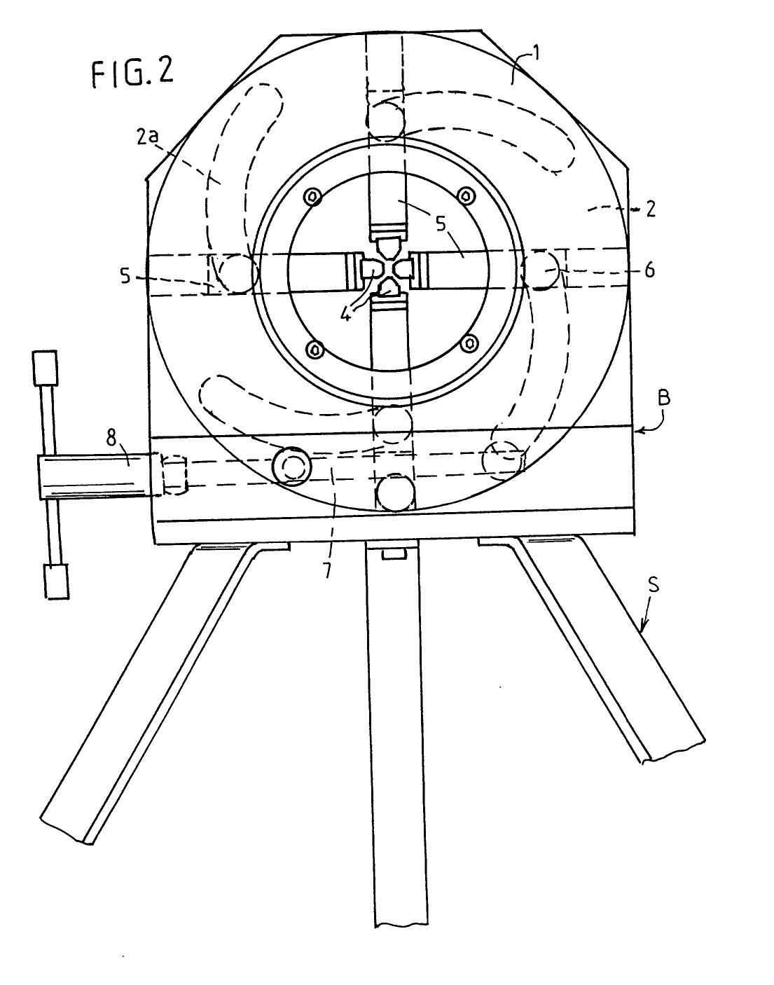

FIG. 2 is a view corresponding to FIG. 1 with the jaws in their maximum clamping position.

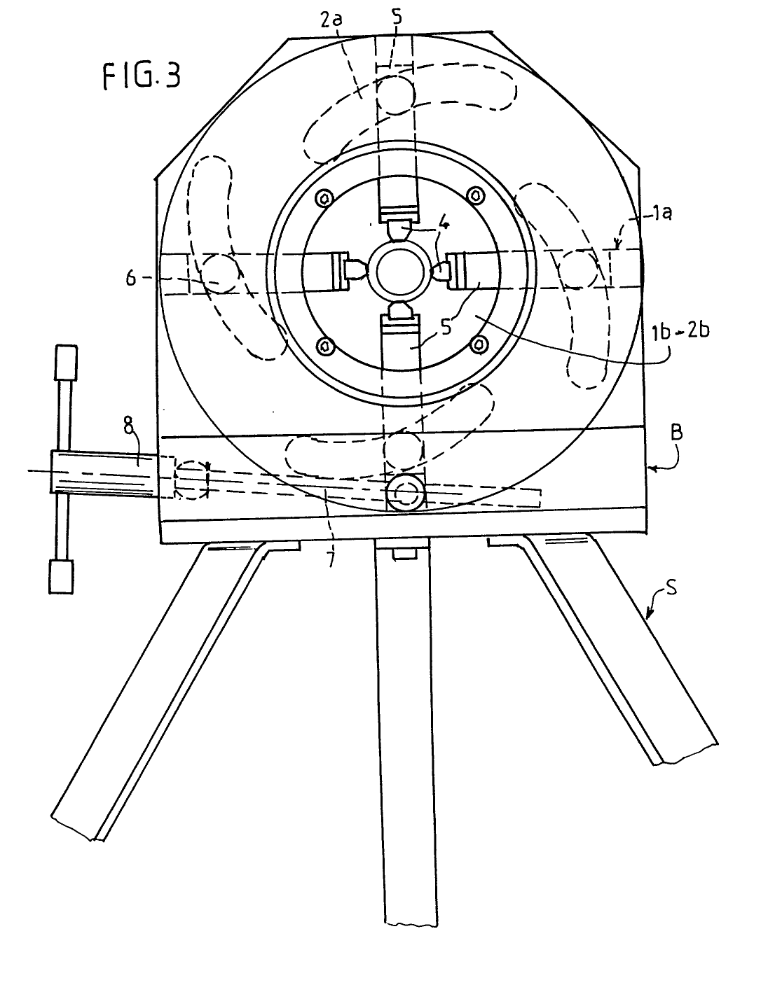

FIG. 3 is a view corresponding to FIG. 1 with the jaws in their intermediate clamping position.

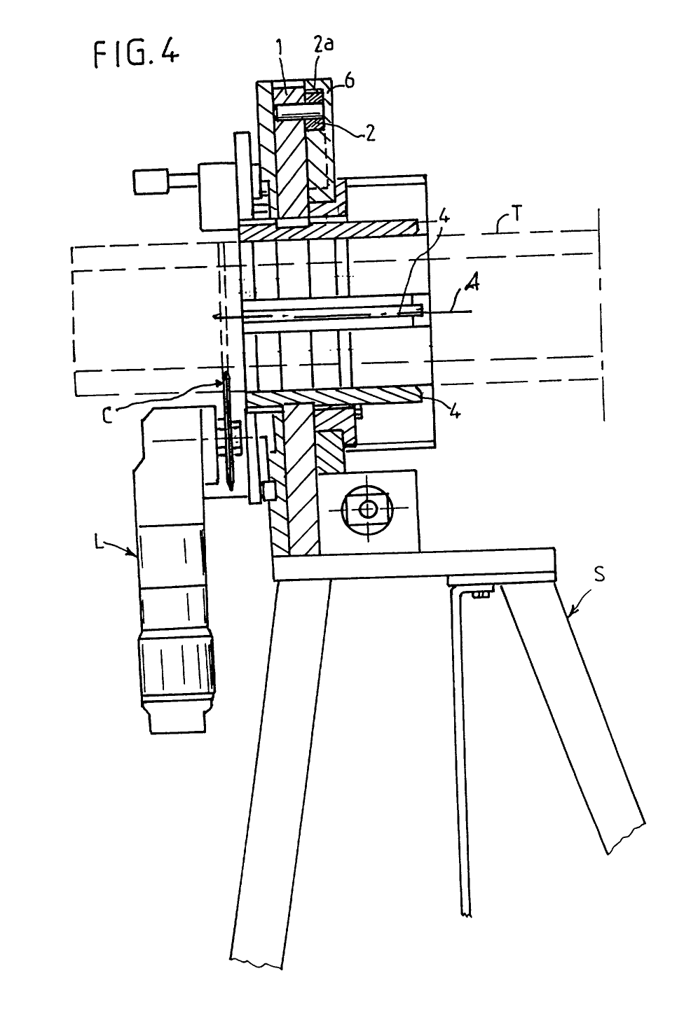

FIG. 4 is a sectional view along line 4.4 in FIG. 1.

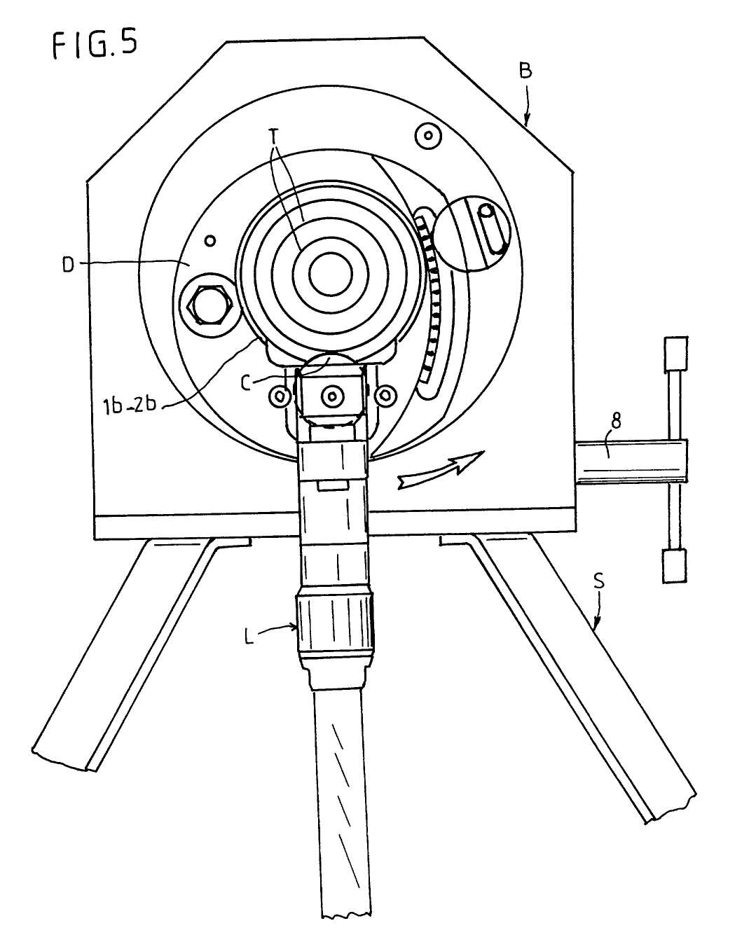

FIG. 5 is a front view showing a typical, but in no way exhaustive, application of the clamping device for an apparatus equipped with a cutting tool that is rotated relative to the tubular component to be processed and moved relative to said component in a circle.

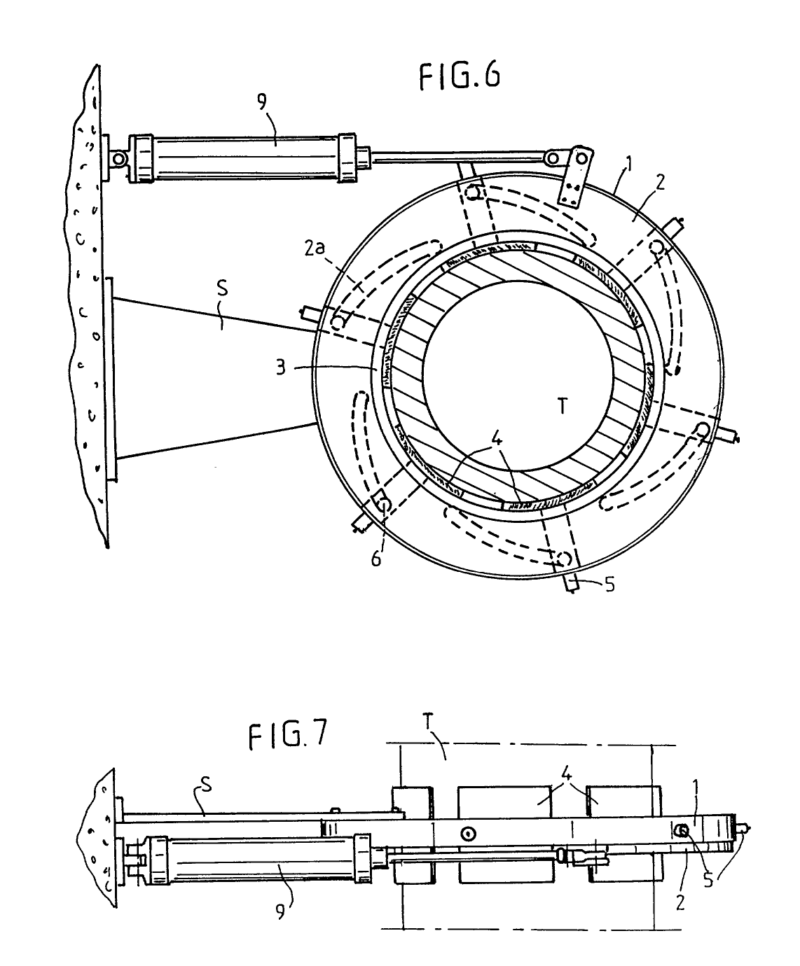

FIG. 6 is a front view showing the clamping device comprising, by way of example, six moveable jaws.

FIG. 7 is a top view corresponding to FIG. 6.

The figures in the accompanying drawings show one application of the clamping device for an apparatus of the type having, as is perfectly familiar, a support frame (B) mounted on a floor stand (S) in the form of a tripod for example. In this typical embodiment, the machining tool in the form of a circular saw blade (C) which may or may not be combined with a chamfering tool (1) is mounted on a lever or arm (L) which can move in a circle relative to the tubular component to be processed (T). For example, the lever (L) is guided by a disc (D) which can be moved in a circular and concentric way relative to the tube (T) secured by the clamping device as such.

This type of apparatus is substantially the same as that described in the cited Patent WO97/27969.

It is important to note that the clamping device that is the subject of the invention has applications for all types of apparatus and may also constitute a completely independent device.

The clamping device uses two concentric rings or plates (1) and (2) arranged so that their faces are opposite each other in a tangential or virtually tangential position. The rings or plates (1) and (2) are mounted so that they can move relative to each other. For instance, a bearing (3) is fitted between the two rings or plates (1) and (2) in order to obtain rotation of roughly 45° between said plates (1) and (2). Plates (1) and (2) therefore have a central opening (1b-2b) in which the tubular component (T) can be fitted.

According to another aspect, plate (1) has features in order to mount jaws (4) so that they are capable of guided translatory motion along a trajectory that is concentric with the tubular component (T) held between the jaws. These features consist of straight impressions (1a) formed in the thickness of plate (1) and opening out into the hollowed centre (1b) of said plate (1) through which the tube (T) is fitted. In each of the impressions (1a) an arm (5) is mounted with the ability to slide in a guided manner and one of the ends (5a) of this arm accommodates jaw (4) as such. The other end of arm (5) opposite that accommodating jaw (4) is fitted with a rotating roller (6) that cooperates with a ramp (2a) formed in the thickness of the plate or ring (2).

Regardless of the number of jaws, each jaw (4) is therefore guided by a ramp (2a) through roller (6). Each ramp (2a) acts as a cam and consists of a semicircular impression in the form of an arc of circle which faces towards the centre of the corresponding plate (2). The length of the arc of each ramp (2a) is determined so that when the corresponding roller is positioned at one of the ends of the impression, jaws (4) are in their maximum spread position (FIG. 1) whereas when said rollers are positioned at the other end of said impression (FIG. 2), the jaws are in their maximum clamping position.

The various cams (2a) of which the number corresponds to the number of jaws, are arranged concentrically in order to allow, as plate (2) is rotated, concomitant translatory and concentric motion of jaws (4) relative to tube (T) placed between said jaws.

Reference is now made to FIGS. 1, 2 and 3 in particular which show the operating principle of the clamping device according to the invention.

In FIG. 1, the various rollers (6) fitted on the corresponding arms (5) of jaws (4) are located at one of the ends of the corresponding ramp (2a) in order to obtain a position of maximum spread between the various jaws (4). Under the effect of rotating plate (2) in the direction shown by arrow (F), because ring (1) remains stationary, each of the rollers of ring (6) moves inside semicircular ramp (2a) and gradually causes, as ring (2) moves in a circle, translatory, guided and concomitant movement of arms (5) on the end of which the jaws (4) are fitted.

FIG. 3 shows an intermediate clamping position whereas FIG. 2 shows the jaws (4) in their maximum clamping position.

Ring (2) which has the cam profiles (2a) is rotated by any manual, semi-automatic or automatic means. For instance, as shown in FIG. 1, moveable ring (2) is controlled by a worm gear system (7) operated by a crank (8). It is also possible to use one or more pneumatic, electric or hydraulic actuators (9) or, more generally, any system making it possible to obtain rotational movement of the two plates (1) and (2). The entire clamping device can be fixed in the thickness or rotated in space.

Given these arrangements, it is possible to use a very large number of jaws which is limited only by the diameter of rings or plates (1) and (2). In the example shown in FIGS. 1 to 5, the device has four clamping jaws which are consequently mounted in four straight impressions (1a) with an angular offset of 90°. The same applies as far as the shaped ramps (2a) are concerned; these are offset by 90° and enclose an angle at the centre of roughly 70°.

In the example in FIGS. 6 and 7, the device has six clamping jaws (4).

Note that the various ramps (2a) may be made using a machining centre which makes it possible to obtain perfect concentricity. Naturally, each clamping ramp is designed depending on the required force, the required travel and the number of ramps depending on the number of clamping jaws.

The advantages are clearly apparent from the description, the following points in particular being underlined and emphasised:

the ability to achieve very high-speed concentric clamping,

inside clearance of jaws ranging from several millimeters to several meters,

the possibility of having a very large number of jaws,

reduced overall dimensions,

reduced weight,

the application of the device to any type of stationary or rotating apparatus.

1- device for clamping a tubular component, especially by means of jaws (4), characterised in that it comprises:
at least two concentric rings or plates (1) (2) arranged so that their faces are opposite each other in a tangential or virtually tangential position,
the rings or plates (1) (2) are mounted so that they can move relative to each other,
one of the plates (1) has features for mounting jaws (4) so that they are capable of guided translatory motion, said features having an even angular offset around the circumference,
each jaw (4) is guided by a ramp (2a) that acts as a cam carried by the other disc or plate (2),
cams (2a) are arranged concentrically in order to allow, during rotation, especially that of plate (2) accommodating said cams (2a), concomitant translatory and concentric motion of the various jaws (4) relative to the component to be processed which is secured between said jaws (4).

2- Device as claimed in claim 1 characterised in that each jaw (4) is guided by a ramp (2a) by means of a roller (6) fitted on an arm (5), one end of which is fitted with said jaw (4).

3- Device as claimed in claim 1 characterised in that the features of plate (1) for movement of jaws (4) consist of parallelepiped impressions (1a) formed in the thickness of said plate in a radial pattern.

4- Device as claimed in claim 3 characterised in that each impression (1a) opens out into an empty space (1b) formed concentrically with the plates and in which the object to be clamped is fitted.

5- Device as claimed in claim 1 characterised in that each ramp (2a) consists of a semicircular impression in an arc of circle facing towards the centre of the corresponding plate (2), the length of the arc being determined so that when rollers (6) are positioned at one of the ends of the corresponding impression (2a), the jaws (4) are in their maximum spread position whereas when said rollers (6) are positioned at the other end of said impression (2a), the jaws (4) are in their maximum clamping position.

6- Device as claimed in claim 1 characterised in that, if it has four clamping jaws (4), the latter are mounted in four straight impressions (1a) with an angular offset of 90° whereas each of the impressions (2a) in an arc of circle enclose an angle at the centre of substantially 70°.

7- Device as claimed in claim 1 characterised in that a bearing is fitted between the two rings or plates (1) and (2) in order to ensure rotation of roughly 45° between said plates (1) and (2).

8- Device as claimed in claim 1 characterised in that one of the plates (2), especially the cam-holder plate, is controlled by manual or automatic means in order to allow rotational movement of the two plates relative to each other.

9- Device as claimed in claim 1 characterised in that a lever is fitted opposite one of the plates with the ability to move along a trajectory that is circular and concentric with said plate, one end of this lever being fitted with at least one rotating tool in order to perform a machining operation on the object clamped between jaws (4).
